(19) United States
(12) Patent Application Publication
(10) Pub. No.: US 2020/0100416 A1
(43) Pub. Date: Apr. 2, 2020

(54) Configurable Water Powered Digging Tool

(71) Applicants: Lawrence Wolff, Scottsdale, AZ (US); Stephen Glick, Scottsdale, AZ (US)

(72) Inventors: Lawrence Wolff, Scottsdale, AZ (US); Stephen Glick, Scottsdale, AZ (US)

(21) Appl. No.: 16/424,757

(22) Filed: May 29, 2019

Related U.S. Application Data
(60) Provisional application No. 62/739,400, filed on Oct. 1, 2018.

(51) Int. Cl. A01B 1/00; E02F 3/02

(52) U.S. Cl. CPC A01B 1/00; E21B 7/18; E02F 3/02

(57) ABSTRACT

A Configurable Water Powered Digging Tool may enable a user to dig a hole in a fraction of the time and a fraction of the effort of traditional digging tools such as shovels and post hole diggers. A Configurable Water Powered Digging Tool may enable a user to purchase a Configurable Water Powered Digging Tool for a fraction of the cost of other water powered digging tools due to simple and rapid, partial disassembly, vastly reduced shipping costs, making the configurable water powered digging tool accessible to many more people. A Configurable Water Powered Digging Tool may enable a user to dig a hole more safely than with other water powered digging tools because of the integrated water valve that enables the user to keep both hands on the handle during operation and the coupler which significantly reduces the likelihood of breaking at the weld where the vertical rod meets the handle. A Configurable Water Powered Digging Tool is comprised of the minimum number of parts to achieve its purpose, thus reducing complexity, manufacturing costs, consumer costs, complexity, repairs and replacements, and increasing safety while reducing effort and time required to achieve an objective.

### BACKGROUND OF THE INVENTION

Traditional digging tools such as post-hole diggers, shovels and grub axes are ineffective and excessively difficult to use in hard soil conditions in many geographic regions. Gas augers are expensive and can be dangerous to operate. Existing water powered digging tools, by nature of their design, are generally limited in their utility due to welded, non-interchangeable components and are prone to breaking at the point where the vertical rod is welded to the handle. They are potentially dangerous due to the need for the operator to remove his or her hands from the handle to control the water flow, and they are expensive to ship due to the overall dimensions of a welded, fully assembled unit. These constraints make traditional or exiting tools impractical and/or inaccessible to the general consumer.

### SUMMARY OF THE INVENTION

The Configurable Water Powered Digging Tool is a unique and significant improvement over all prior art. In different embodiments, it is designed in two or three parts with a coupling that is significantly stronger than prior welded designs. The integrated control valve is built into the handle so the operator never has to let go of the handle to control the water flow. The two or three parts can be shipped for a fraction of the cost of prior designs due to the smaller dimensions of the disassembled unit (i.e. the parts are packed parallel to each other, rather than in a perpendicular assembled unit, thus reducing the size of the packaging which reduces shipping costs. By replacing the weld(s) with coupling(s), the vertical rod becomes interchangeable, enabling the operator to choose a wider or narrower diameter, thus decreasing or increasing water pressure, and the rods may include varying tips, enabling water to be directed in varying directions as required by different soil conditions and applications. Further, the rods themselves may be connected with a coupling enabling the increasing or decreasing of the length of the unit by adding or removing sections of rod, thus enabling the operator to dig deeper holes with longer rods.

### BRIEF DESCRIPTION OF THE DRAWING FIGURES

FIG. 1 shows the Configurable Water Powered Digging Tool. A 120 Valve is threaded onto 110 Handle and 130 Swivel is threaded onto 120 Valve. 130 Swivel is designed to attach an ordinary garden hose (not shown). 140 Coupler is welded to 110 handle at 142 Weld. Interchangeable 150 Rod with Tapered Top (or 160 Sectioned Rod) slides into 140 Coupler creating a watertight seal.

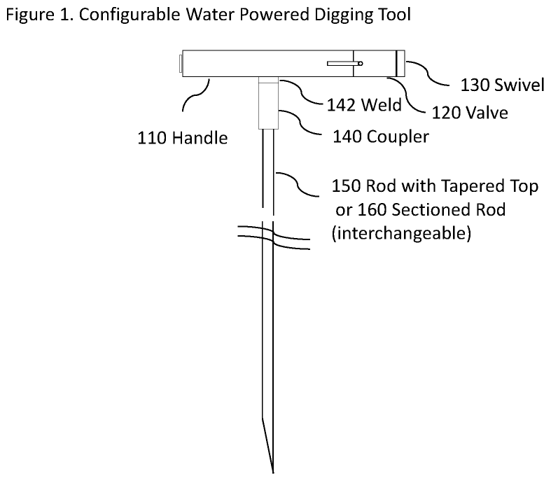

FIG. 2 shows 110 Handle, a hollow steel pipe, with 112 Cap threaded into one end to prevent leakage of water. 118 Threading on the other end of 110 Handle is where the 120 Valve attaches. 114 Hole is where 140 Coupler is attached to 110 Handle using 142 Weld.

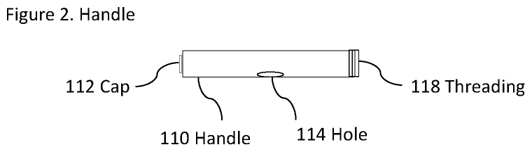

FIG. 3 shows 120 Valve threaded onto 118 Threading of 110 Handle. 120 Valve is operated using 122 Valve Handle. 120 Valve is a common ball valve made of brass or other material.

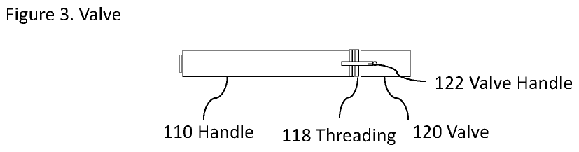

FIG. 4 shows 130 Swivel threaded onto 120 Valve. This assembly facilitates connecting an ordinary garden hose to provide water to the Configurable Water Powered Digging Tool. 130 Swivel prevents twisting and kinking of the garden hose.

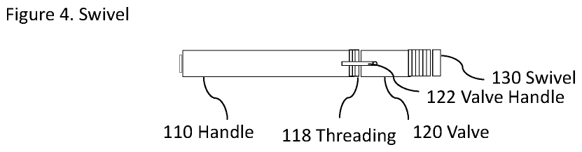

FIG. 5 shows 140 Coupler which gets welded to 110 Handle with 142 Weld and receives 150 Rod With Tapered Top. 140 Coupler is a solid steel rod that is drilled from the top to the inside dimension of 150 Rod With Tapered Top and drilled from the bottom to the outside dimension of 150 Rod With Tapered Top. Drilling from the bottom leaves 144 Angled Shoulder for 150 Rod With Tapered Top to fit securely into, resulting in a water tight seal without the need for O-rings or gaskets. 148 Thumb Screw is threaded into 146 Threaded Hole in 140 Coupler to secure 150 Rod With Tapered Top.

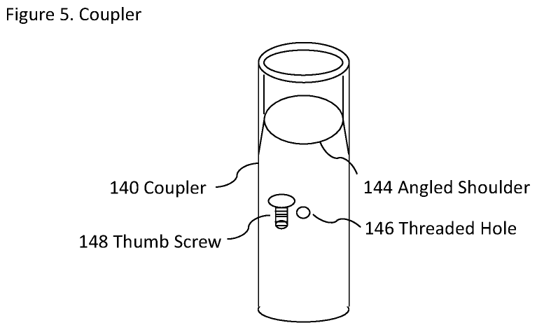

FIG. 6 shows 150 Rod With Tapered Top, including the top taper that fits securely into 144 Angled Shoulder of 140 Coupler to create a watertight seal and 151 Angle Cut through which water exits the Configurable Water Powered Digging Tool to push away soil or other material to dig a hole. 150 Rod With Tapered Top may easily be replaced with a different 150 Rod With Tapered Top or 160 Sectioned Rod of varying configurations for different digging conditions.

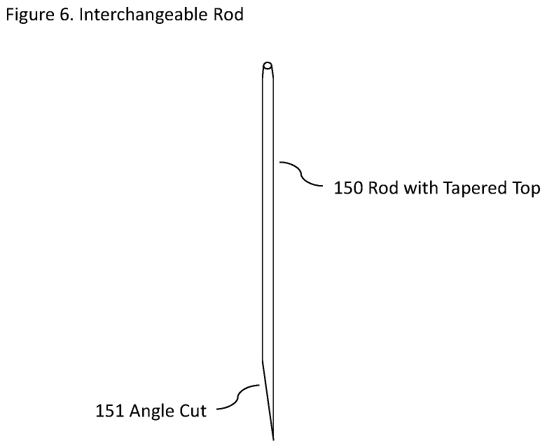

FIG. 7 shows 140 Coupler welded to 110 Handle with 142 Weld and 150 Rod With Tapered Top inserted into 140 Coupler with the tapered top of 150 Rod With Tapered Top seating tightly into 144 Angled Shoulder of 140 Coupler to prevent water leakage when the Configurable Water Powered Digging Tool is operated.

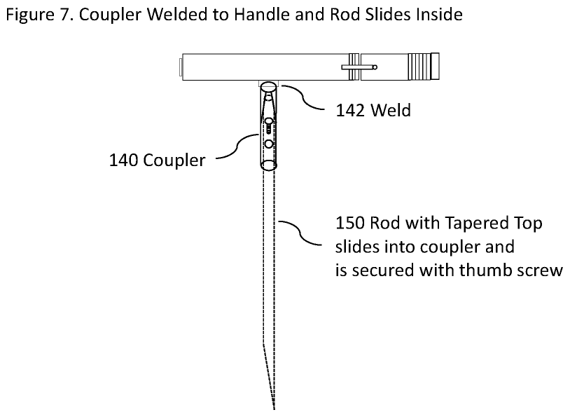

FIG. 8 shows 160 Sectioned Rod consisting of 154 Rod Section Coupler connecting 152 Upper Rod Section with Tapered Top and Tapered Bottom and 153 Lower Rod Section with Tapered Top. 152 Upper Rod Section and 153 Lower Rod Section are secured by tightening 164 Thumb Screw in 162 Threaded Hole and 168 Thumb Screw in 166 Threaded Hole. In other embodiments 151 Angle Cut on 153 Lower Rod Section may be replaced with a straight bottom or a straight bottom with holes around the perimeter or other configurations to suit different digging conditions.

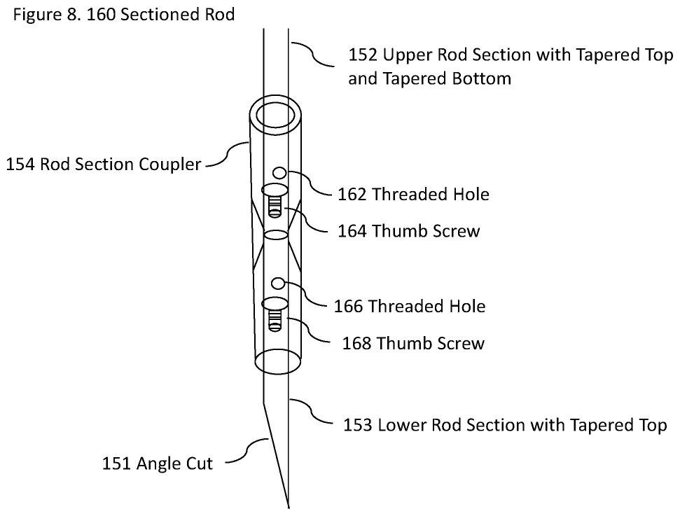

FIG. 9 shows the Configurable Water Powered Digging Tool being used in a circular motion to control the diameter of the hole being dug.

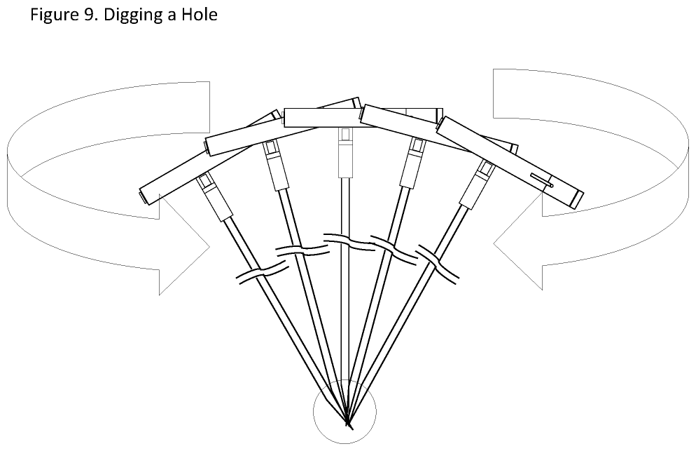

FIG. 10 shows the general material used in the construction of one embodiment of the Configurable Water Powered Digging Tool, specifying schedule 80 steel pipe, schedule 40 steel pipe, and various diameters and dimensions. One embodiment may use galvanized steel. One other embodiment may use black steel.

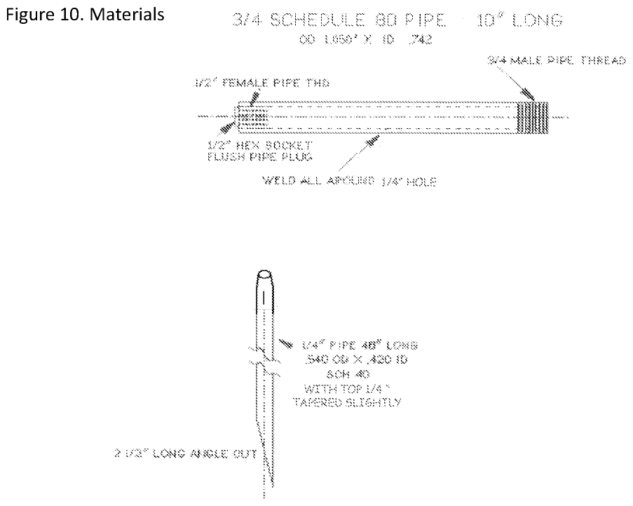

### DETAILED DESCRIPTION OF EXEMPLARY EMBODIMENTS

The Configurable Water Powered Digging Tool digs holes effortlessly by using water pressure instead of the work effort associated with traditional digging tools.

In one embodiment the Configurable Water Powered Digging Tool uses water pressure to push the soil away from the tool, creating a hole in the ground. Water enters the tool through an ordinary garden hose and then passes through a narrow rod, increasing the water pressure and moving the soil. Interchangeable rods enable the operator to choose a wider or narrower diameter, thus decreasing or increasing the water pressure to suit the ground conditions and to adjust the length of the rod for deeper or shallower holes and to change the configuration of the tip of the rod depending on ground conditions and the nature of digging required (e.g. digging a hole versus digging a trench).

The operator connects an ordinary garden hose to the valve on the handle of the tool and turns on the water. The operator then places the tip of the rod onto the spot where digging is to begin and opens the valve on the handle to begin the water flow. As the water passes through the narrow rod, pressure increases and the water exiting the rod pushes the soil out of the way, creating a hole. The operator controls the water flow by adjusting the valve on the handle. The operator controls the diameter of the hole by rotating the handle in a circular motion, thus widening the hole.

1. A configurable water powered digging tool comprising:
a handle with one open end to receive water and a hole through which the water may exit;
a coupler connected to the hole in the handle and through which water may pass;
and an interchangeable rod of smaller diameter than the handle and that connects to the coupler and through which the water passes.

2. A configurable water powered digging tool as defined in claim 1 wherein:
the handle first described in claim 1 may be comprised of a steel tube threaded at one end and capped at the other end and with a hole of equal or unequal diameter to the diameter of the steel tube located anywhere along the length of the steel tube;
an adjustable ball valve may be attached to the threaded end of the steel rod;
and a swivel connector capable of connecting to an ordinary garden hose may be attached to the adjustable ball valve.

3. A configurable water powered digging tool as defined in claim 1 wherein:
the coupler first described in claim 1 may be comprised of a solid steel rod that is drilled at the top to an inside diameter equal to the hole in the steel pipe of the handle as described in claim 2;
is drilled at the bottom to an inside diameter equal to the outside diameter of the rod described in claim 1 and further described in claim 4;
includes a taper that may be equal to, greater than or less than 45 degrees where the hole drilled from the bottom meets the hole drilled from the top, forming a shoulder on which the interchangeable rod described in claim 1 and further described in claim 4 may rest and form a seal to prevent water from leaking;
contains a threaded hole along the length of the drilled, solid steel rod;
and includes a thumb screw to thread into said threaded hole to secure the interchangeable rod described in claim 1 and further described in claim 4.

4. A configurable water powered digging tool as defined in claim 1 wherein:
the interchangeable rod first described in claim 1 may be comprised of a steel tube with outside diameter equal to the inside diameter of the hole drilled in the bottom of the coupler described in claim 3;
may have the top tapered to the exact angle of the shoulder drilled in the coupler described in claim 3;
may be inserted into the coupler described in claim 3 to form a watertight seal without the use of an O-ring, substance, or any other means of sealing the junction between the interchangeable rod and the coupler;
may have any of a variety of angled cuts and/or holes at the bottom to direct water to perform various tasks.
